(19) United States
(12) Patent Application Publication
(10) Pub. No.: US 2024/0110841 A1
(43) Pub. Date: Apr. 4, 2024

(54) APPARATUS AND METHODS FOR LEAK TESTING OF HERMETIC MICROELECTRONICS

(71) Applicant: The United States of America, as represented by the Secretary of the Navy, Crane, IN (US)

(72) Inventors: Brandon Hirsch, Bloomington, IN (US); Matthew Keller, Bloomington, IN (US); Stephen Becker, Loogootee, IN (US); Michael A. Samp, Champaign, IL (US)

(73) Assignee: The United States of America, as represented by the Secretary of the Navy, Arlington, VA (US)

(21) Appl. No.: 18/376,579

(22) Filed: Oct. 4, 2023

Related U.S. Application Data
(60) Provisional application No. 63/413,096, filed on Oct. 4, 2022.

(51) Int. Cl. G01M 3/20

(52) U.S. Cl. CPC G01M 3/205

(57) ABSTRACT

Provided are methods and associated apparatus for determining the integrity of a hermetically sealed electronic component. The method and associated apparatus includes the use of an evacuation chamber configured to placing the hermetically sealed electronic component within. The evacuation chamber is then evacuated of atmosphere to then determine an atmospheric pressure evacuation relationship or curve occurring inside the chamber that is, in turn, used to determine the integrity of the hermetically sealed electronic component. Further aspects may include evacuating the chamber through a mass spectrometer coupled to the evacuation chamber for chemical analysis of at least one of the evacuated atmosphere for making further determinations of the integrity of the hermetically sealed electronic component.

### CROSS-REFERENCE TO RELATED APPLICATIONS

The present application claims the benefit of and priority to U.S. Provisional Patent Application Ser. No. 63/413,096, filed Oct. 4, 2022, and entitled “APPARATUS AND METHODS FOR LEAK TESTING OF HERMETIC MICROELECTRONICS,” the disclosure of which is expressly incorporated by reference herein.

### STATEMENT REGARDING FEDERALLY SPONSORED RESEARCH OR DEVELOPMENT

The invention described herein was made in the performance of official duties by employees of the Department of the Navy and may be manufactured, used and licensed by or for the United States Government for any governmental purpose without payment of any royalties thereon. This invention (Navy Case 211232US02) is assigned to the United States Government and is available for licensing for commercial purposes. Licensing and technical inquiries may be directed to the Technology Transfer Office, Naval Surface Warfare Center Crane, email: Crane_T2@navy.mil.

### FIELD

The present disclosure generally relates to testing of microelectronic components and, more particularly, to methods and associated apparatus for leak testing of hermetic microelectronics components designed to have an airtight seal in order to determine the hermetic integrity of such components.

### BACKGROUND

Hermetically sealed electronic components including a die and circuitry within a hermetically sealed package are commonplace in strategic systems, medical devices, and other rugged or critical applications. Without such sealing, the components will likely fail from external stimuli such as moisture, radiation, pressure, and so forth. These hermetic devices began to appear in the 1960s after high-profile failures of microelectronic devices inside space launch systems. Testing procedures used to validate the integrity of hermetic seals were proposed throughout the 1970s and have become commonplace in testing workflows from manufacturers and end users alike to ensure the validity of the components inside their systems.

For military applications, examples of current test methods of hermetically sealed electronic components are laid out in detail in Military Standard (MIL-STD) 750 test method 1071 and MIL-STD-883 test method 1014, which are maintained by the Defense Logistics Agency (DLA). In particular, leak testing of such components is typically performed by pressurizing the atmosphere around the hermetically sealed package with a tracer gas, such as Helium, or a radioisotope, such as Krypton-85, and then measuring off gassing of the tracer gas or radioisotope (i.e., measuring the amount of gas or radioisotope leaving or leaking from the electronic components under test). This approach, however, is not 100% effective especially with known instances of “one-way leakers,” which are devices that may allow the tracer gas to enter but the gas then fails to off gas. Such untraceable instances of “one-way leakers” result from excessive inward forces being placed on the components under test and testing of such devices then yields inaccurate results. Accordingly, there is a need for improved testing of hermetically sealed electronic components that will accurately test all hermetically sealed electronic components including one-way leaker devices, for example.

### SUMMARY

The present disclosure includes a method to examine the leak rate of hermetically sealed microelectronic components. In one example, the method includes use of a vacuum system containing a mass spectrometer for chemical analysis with a load-lock system capable of temporarily isolating the main chamber to accommodate the microelectronic device under test (DUT). Once the device under test is introduced to the chamber, release of the load-lock enables evacuation of the microelectronic device, along with monitoring the emerging chemical components from the device using the mass spectrometer. Monitoring the area under an evacuation curve (i.e., the evacuation correlating to evacuation of the interior of the DUT) alongside the constituent chemical components, for example, supports a direct measurement of the DUT leak rate.

In aspects, a method is disclosed for determining the integrity of a hermetically sealed electronic component. The method includes placing the hermetically sealed electronic component in an evacuation chamber, and evacuating the evacuation chamber of atmosphere through a mass spectrometer coupled to the evacuation chamber for chemical analysis of at least one of the evacuated atmosphere and a determination of an atmospheric pressure evacuation relationship inside the evacuation chamber to determine integrity of the hermetically sealed electronic component.

According to further aspects, a method for determining the integrity of a hermetically sealed electronic component is disclosed. The method includes placing the hermetically sealed electronic component in an evacuation chamber, and evacuating the evacuation chamber of atmosphere through a mass spectrometer coupled to the evacuation chamber for chemical analysis of at least one of the evacuated atmosphere and a determination of an atmospheric pressure evacuation relationship inside the evacuation chamber to determine integrity of the hermetically sealed electronic component.

In yet further aspects, an apparatus is disclosed for determining the integrity of a hermetically sealed electronic component. The apparatus includes an evacuation chamber configured to receive the hermetically sealed electronic component, and an evacuation pump coupled to the evacuation chamber and configured to evacuate atmosphere from the evacuation chamber. Furthermore, the apparatus includes a controller communicatively coupled to the mass spectrometer and configured to determine an atmospheric pressure evacuation relationship inside the evacuation chamber to determine the integrity of the hermetically sealed electronic component.

Additional features and advantages of the present invention will become apparent to those skilled in the art upon consideration of the following detailed description of the illustrative embodiments exemplifying the best mode of carrying out the invention as presently perceived.

### BRIEF DESCRIPTION OF THE DRAWINGS

The detailed description particularly refers to the accompanying figures in which:

FIG. 1 illustrates an example of a basic layout for an apparatus used for determining the integrity of hermetically sealed electronic components according to some aspects of the present disclosure.

FIG. 2 illustrates one exemplary “clam-shell” configuration of an evacuation chamber that may be utilized in the apparatus shown in FIG. 1 according to some aspects of the present disclosure.

FIG. 3 illustrates another exemplary “clam-shell” configuration of evacuation chamber that may be utilized in the apparatus shown in FIG. 1 according to some aspects.

FIG. 4 illustrates examples of evacuation curves illustrating differences between good (i.e., non-leaking) components and bad (i.e., leaking) components according to some aspects of the present disclosure.

FIG. 5 illustrates examples of reference evacuation curves and measurements from a good device (non-leaker) and a bad device (gross leaker) for reference according to some aspects of the present disclosure.

FIG. 6 illustrates an example of testing evacuation results including gross leak detection according to some aspects of the present disclosure.

FIG. 7 illustrates an exemplary method and apparatus through which a device under test is baked prior to leak testing according to some aspects of the present disclosure.

FIG. 8 illustrates evacuation curves showing the difference between cold and hold devices under test according to some aspects of the present disclosure.

FIG. 9 illustrates a flowchart of an exemplary method for performing evacuation testing of a hermetically sealed electronic device according to some aspects of the present disclosure.

FIG. 10 illustrates a flowchart of another exemplary method for performing evacuation testing of a hermetically sealed electronic device according to some aspects of the present disclosure.

### DETAILED DESCRIPTION

The embodiments and examples of the invention described herein are not intended to be exhaustive or to limit the present disclosure to the precise forms disclosed. Rather, the embodiments or examples selected for description have been chosen to enable one skilled in the art to practice the invention or inventive concepts.

The presently disclosed methods and apparatus represent a fundamental shift in leak testing where, instead of trying to force a tracer gas inside a hermetically sealed package, the interior of the package is pumped out or evacuated without use of a tracer gas and the chemical composition of the evacuated atmosphere is analyzed for detecting packages with compromised hermeticity. This testing is a non-destructive test that places outward forces on the device and provides a direct measurement of individual package leak rates to determine suitability.

Furthermore, the methodology may employ machine-learning analysis of two-dimensional X-ray imaging of the lid seal material and lead eyelets to improve screening effectiveness. Current standards limit acceptance criteria to a voiding percentage of the lid seal. A correlational analysis between machine learning parameters of x-ray images and evacuation leak rates can provide improved data analysis techniques, as well as a streamlined approach for screening hermetic components.

Still further, in some aspects the present methods (and the associated apparatus in some cases) are a proposed development for a new standardized testing of hermetic microelectronics. As currently implemented, the military standards defining the testing requirements are outlined in MIL-STD-883-1 TM 1014.18 and MIL-STD-750-1B TM 1071. These standards define acceptable test methods for the “Seal” or “Hermetic Seal” tests, respectively. This test method is used to determine the hermetic seal integrity of a microelectronic device. Both MIL-STD test methods outline similar test requirements, with the differences being the microelectronic component class governance. MIL-STD-883K governs integrated circuit devices, while MIL-STD-750-1A governs passive and discrete devices. Within both test methods (TM 1014.18 and TM 1071.17) various test conditions are described. These conditions outline the acceptable procedures used for evaluating hermetic seal integrity. The conditions include bombing the devices inside chambers that are filled with a tracer gas and then removing the devices from the bomb and looking for off-gassing signals of this tracer gas. Other known test conditions describe bombing in a leak test fluids (perfluorocarbons) followed by subsequent optical detection of bubbles. Additional options may include lid seal deflection laser measurements on a device under test.

In a particular aspect, the presently disclosed methodology proposes developments to condition H3 in MIL-STD-750-1B TM 1071.17 and condition A5 in MIL-STD-883-1 TM 1014.17. Both test methods describe the use of condition “[c]ombined helium (He)/oxygen (O₂) dry gross leak, and He fine leak.” During this test method, microelectronic devices are bombed inside of a chamber using He as a tracer gas. After the bomb has concluded, the devices are placed inside an instrument including a sealed instrument chamber that affords quantitative analysis using mass spectrometry. Inside the sealed instrument chamber in particular the devices are evacuated under an elevated temperature. The gas content is monitored during the evacuation of the chamber. Gross leaks are characterized by the He/O₂ concentration when compared to a reference standard. Fine leaks are determined by the Helium concentration when compared to a reference standard.

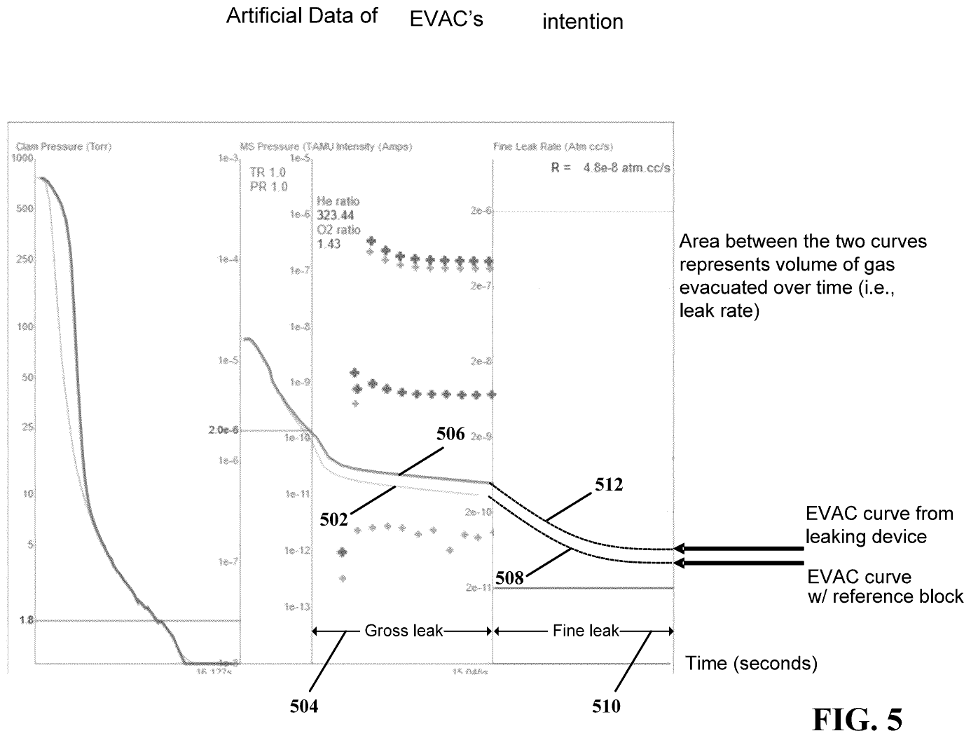

In contrast to the testing methods above, the presently disclosed evacuation methodology proposes the same evacuation process of the device being tested, but the He bomb at the beginning of the test is eliminated. The gross leak rate is measured, similar to the currently proposed fine leak measurement standard. FIG. 5 shows a representative demonstration of gross leak. The fine leak rate is determined by monitoring the He/O₂ concentration from the mass spectrometer, as well as moisture (H₂O), nitrogen (N₂), and Argon (Ar) monitored directly during the evacuation process. In other words, rather than examine only the off-gassing of the He for the fine leak rate, the fine leak rate is determined by monitoring the pressure curve during the evacuation, while also monitoring the constituent gaseous components using the mass spectrometer. A comparison of the pressure curve and the signals obtained from each gaseous component during the evacuation process to a reference provides a direct measurement of the leak rate from each individual device.

Additionally, the present methods may also incorporate processes to engender a desorption of moisture from the surfaces devices under test using this evacuation based leak detection for optimization of the detection using mass spectrometry. In some aspects, the removal of adsorbed moisture may be accomplished with prolonged thermal bake-outs of the devices (i.e., heating of the devices over a prolonged period).

The present disclosed methods and apparatus provide a benefit in that elimination of tracer gases currently used inside leak testing is afforded. This is particularly salient in that radioactive Krypton-85 and Helium gas currently employed for leak testing are expensive and in short supply. Accordingly, with the present methods and apparatus these gases will no longer be necessary to accurately determine the leak rate of a microelectronic device. The proposed evacuation method may further be applicable to other areas where airtight seals are necessary and the volume of gas to be isolated from an external atmosphere is small such as approximately 1.0 cubic centimeters or less.

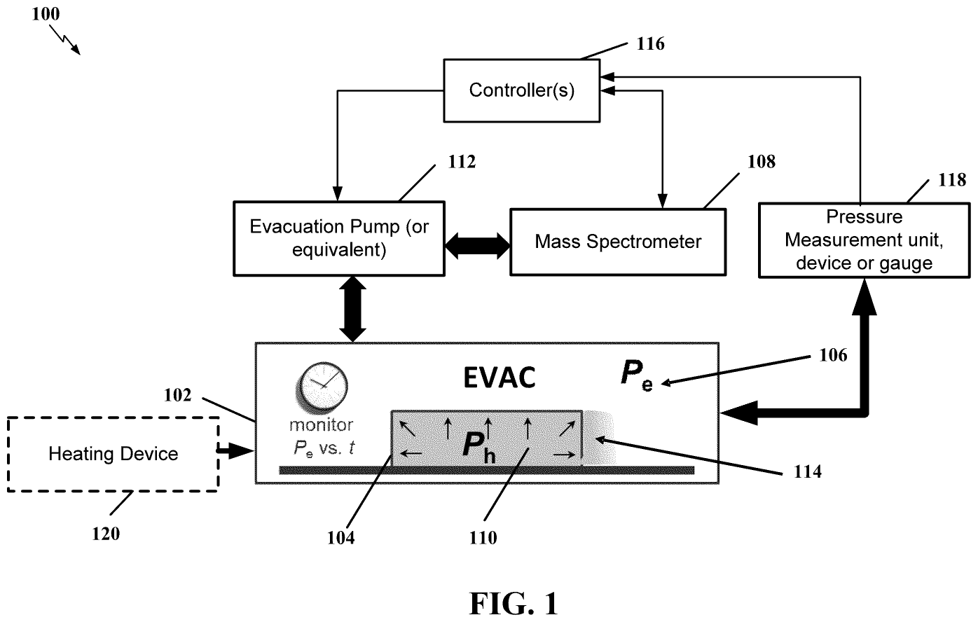

FIG. 1 illustrates an exemplary system 100 for testing the integrity of a hermetically sealed electronic component using the disclosed evacuation methodology according to aspects of the present disclosure. As illustrated, the system 100 includes an evacuation chamber 102 within which a device under test (DUT) 104 is disposed or placed. Additionally, the chamber 102 defines an interior volume, which has a pressure P e as shown at 106. Furthermore, the chamber 102 (via an evacuation pump 112 as shown, or directly in other examples) is coupled to a mass spectrometer 108 (or equivalents) configured for chemical analysis of the evacuated atmosphere in chamber 106 through mass spectrometry resultant from a vacuum created by the pump 112. It will be appreciated by those skilled in the art that the DUT 104 will have an interior volume 110 at a pressure Ph. When a vacuum is created by the evacuation pump 112 coupled to the chamber 102, if the integrity of the package 104 is compromised, trace chemicals (e.g., He, water, etc.) will evacuate from the package 104 as shown by a representative cloud 114 (shown for illustration only and not intended to accurately show or limit the shape/volume to such), which may then be analyzed by the mass spectrometer 108.

Apparatus 100 further includes one or more controllers 116 that are communicatively coupled with the evacuation pump 112 and the mass spectrometer 108. In aspects, controller 116 is configured to control the evacuation pump 112 for evacuating the chamber 102 to one or more predetermined pressures. In some further aspects, controller 116 may also be configured to, among other things, read data gathered from the mass spectrometer 108, perform calculations for determining evacuation curves, calculate or determine leak rates of devices under test including determinations based on comparison to determined or predetermined evacuation curves, and store and update one or more databases of evacuation curves for one or more various devices/packages that may be tested by the apparatus.

Furthermore, in certain aspects controller 116 may include at least one processing system including one or more processors responsible for processing, including the execution of computer executable code or software stored on a computer-readable medium (not shown). Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software, when executed by the controller 116, causes the processing system to perform the various functions described herein for any particular apparatus such as apparatus 100. The computer-readable medium may also be used for storing data that is manipulated by the controller 116 when executing software.

In further aspects, computer-readable medium utilized by controller 116 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may reside in the processing system of controller 116, external to the processing system of controller 116, or distributed across multiple entities including the processing system of controller 116. The computer-readable medium may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

Is still further aspects, a pressure measurement unit or gauge 118 may be employed to determine the internal pressure 106 in chamber 102. The pressure measurement may be sent to the controller 116, which in turn utilizes the pressure measurements to determine evacuation curves as will be discussed later. Moreover, apparatus 100 may include an optional heating device 120 for preheating the chamber 102 and DUT 104 for removing adsorbed moisture or water molecules, as will be discussed in more detail later.

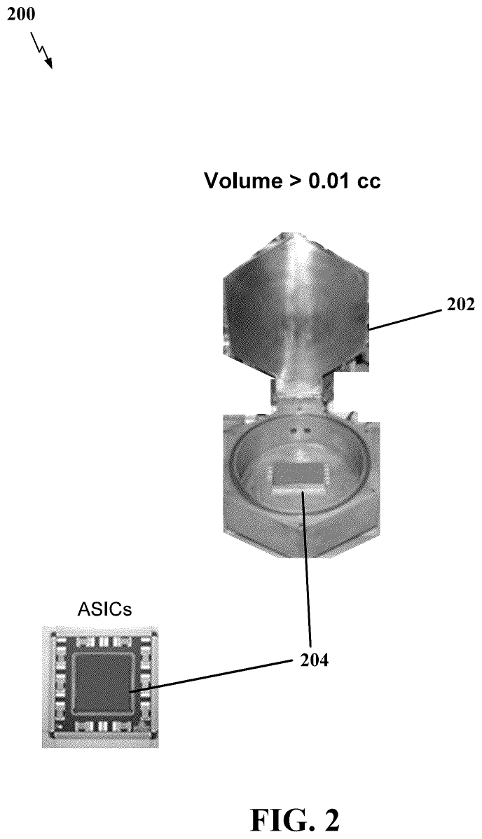

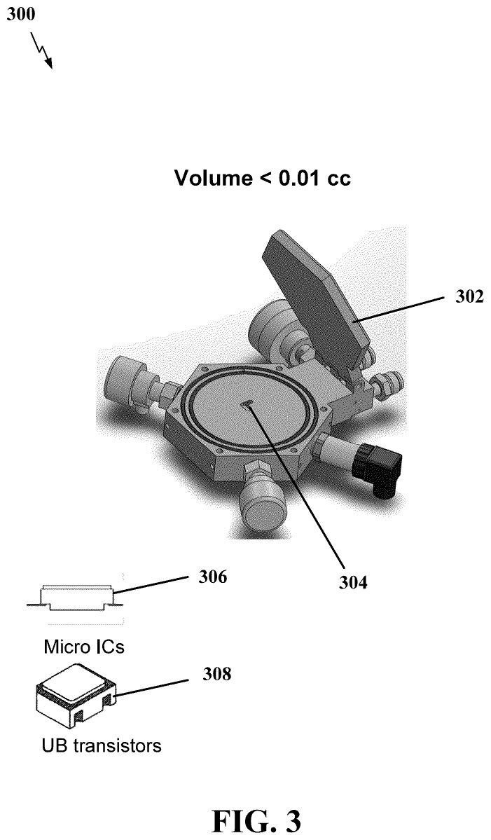

According to further aspects, the system 100 may be embodied with use of an instrument developed by Oneida Research Services (e.g., model HSHLD 3105) as merely one example. Examples of parts of the apparatus 100 are illustrated by particular “clamshell” configurations for the evacuation chamber (e.g., chamber 102 in FIG. 1), which are illustrated in FIGS. 2 and 3. In particular, FIG. 2 illustrates a portion 200 of system 100 (e.g., an exemplary configuration for evacuation chamber 102 in FIG. 1) at 202, which is a clamshell type chamber that may be used for larger volumes (e.g., for ASIC devices 204 as shown within an interior of the portion 200 for testing and also illustrated singularly for clearer illustration and understanding of the type of microelectronics device type). In this particular example, the volumes may be greater than approximately 0.01 cubic centimeters (cc).

Another exemplary configuration portion 300 is shown in FIG. 3 for smaller volume packages to be tested. In this example, another clamshell configuration for a portion (e.g., the chamber such as 102) of apparatus 100 is shown at 302. An interior of portion 302 may include a shaped notch or hollowed out volume 304 that is configured to hold a particular package under test. Package types may include micro ICs 306 or UB transistors 308, as merely two examples. The configuration illustrated in FIG. 3 may be used for packages having smaller volumes of approximately 0.01 cc or less.

In further aspects, the system 100 and mass spectrometer 108 in particular of FIG. 1 may be configured to monitor the “gross” leak rate by examining the ratiometric value between an He/O₂ concentration during evacuation compared to a reference curve. In one aspect, this reference curve may be generated by evacuating chamber 102 containing a filler block in place of the device under test (e.g., DUT 104). During the actual test, the component (e.g., 104) replaces the filler block and the evacuation curve and the He/O₂ concentration are rerecorded and compared to the reference value. When these values fall outside of an allotted range when compared to reference, the device is labeled a gross leaker.

Of further note, for the currently disclosed methods, in order to perform “fine” leak detection, the evacuation process continues below a pressure of approximately 1×10⁻⁶ Torr. However, the mass spectrometer begins to look only for helium (He) at this pressure. As was described before, the currently known test methods first bomb components inside of a He chamber to attempt to push He gas inside the component. Thus the “fine” leak portion of those tests compare the He signal observed from the device under test to known referenced values of He leak standards that are typically purchased and calibrated by an outside lab. In this manner, the presently disclosed apparatus may follow traditional test method practices for fine leak measurement. Parts are subjected to pressure under tracer gas (He) and then the measurement of the tracer off-gassing determines the leak rate when compared to standard calibrated He leak rates. Alongside the construction of the HSHLD 310s instrument, for example, it is noted here that Oneida Research Services introduced an He/O₂ evacuation curve “gross” leak measurement to the standards in 2015. However, the technological evolution of leak testing is slow, so the jump to full evacuation curve measurements as direct representations of the leak rate for hermetically sealed microelectronics was not proposed or suggested.

Accordingly, the presently disclosed apparatus and methods provide a technique that moves away from use of tracer gases (He) and instead leverages the use of evacuation curves of each component for determining leak rates, among other things. It is also noted that evacuation methods have been used in other sectors to identify, but not to quantitate, leaks inside of large storage vessels when a tracer gases cannot be used. The present methods are based, in part, on both observed and theorized results that a leak detection instrument such as the HSHLD 310s helium leak detection instrument (or equivalents) is capable of performing an evacuation measurement in a quantitative fashion and directly correlating the evacuation measurement to the leak rate.

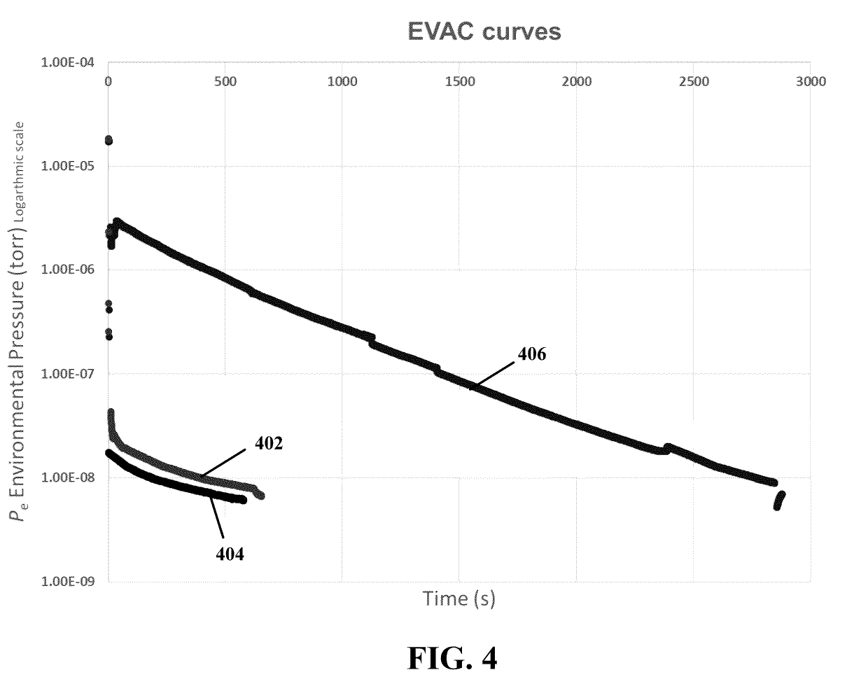

FIG. 4 illustrates examples of reference evacuation curves and measurements from a good device (non-leaker) and a bad device (e.g., a gross leaker) for reference. The evacuation curves give an indication of a leaking component when compared to a reference of the empty load-lock (e.g., an evacuation curve generated using a reference block rather than a device to be tested). As may be seen in the plots, a good component (curve 402) of the measured Pₑ environmental pressure closely follows a reference curve (curve 404) over time. The integrated difference between the two curves provides the direct leak rate measurement. When the DUT is adequately sealed as in the case of curve 402, there is relatively little gas emerging from the DUT over time. Thus curve 402 nearly matches that of the reference curve 404. In contrast, a bad or failed component curve 406 may be seen as clearly differentiated. The evacuation plot shown in 406 resides above the 402 and 404 curves as a result of a significant amount of gas is being evacuated from the DUT over a much longer period of time.

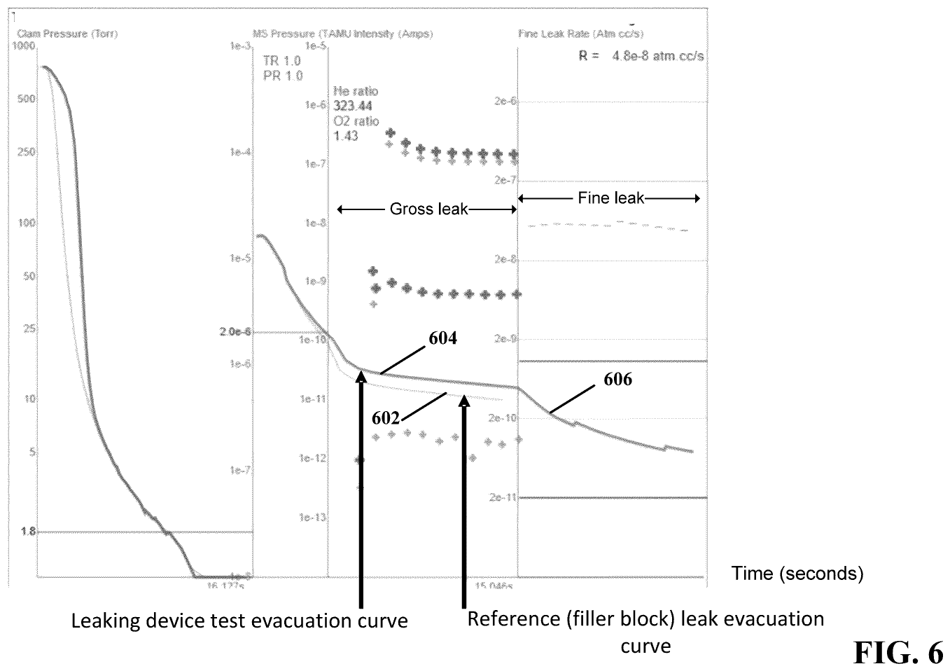

FIGS. 5 and 6 respectively illustrate further examples of evacuation curves (i.e., pressure of the evacuation chamber over time) based on both theoretical evacuation results and testing results. It is noted that the integrated area between the curves illustrated may represent a volume of gas evacuated over time, i.e., the leak rate. For FIG. 5 in particular, a reference evacuation (EVAC) curve 502 for a reference block is shown during a time over a gross leak timeline or period 504. A curve 506 represents the evacuation curve from the device under test during period 504, which in this case may be a leaking device. Furthermore, after the gross leak timeline 504, the fine leak may be predicted (in this case the plot is a theoretical) or measured and then determined based on the difference of the reference curve (shown at 508) over a fine leak timeline or period 510 and the evacuation curve 512 resultant in this period 510 from the DUT in the evacuation chamber. It is noted that the curves represented in FIG. 5 are merely exemplary and the values and shapes/slopes will vary based on the type of device under test.

Concerning FIG. 6, this figure illustrates another example of evacuation curves determined using an Oneida Research Services model HSHLD 310S helium leak detection instrument using combined He and O₂ leak detection. A reference evacuation (EVAC) curve 602 for a reference or filler block is shown during a time over a gross leak timeline or period. Curve 604 represents the evacuation curve from the device under test, which in this case may be a leaking device during the same gross leak period. Furthermore, after the gross leak timeline, the fine leak may be predicted or measured and then determined based on the difference with a reference curve 606 over the fine leak timeline or period. It is noted that the curves represented in FIG. 6 are merely exemplary and the values and shapes/slopes will vary based on the type of device under test.

Monitoring the full spectrum of constituent gases (1-140 amu) during the evacuation curve provides insight into the gases that emerge from the device under test as it is being evacuated below 1×10⁻⁶ Torr, for example. In order to apply the same methodology of detecting a “gross” leak to the detection and measurement of a “fine” leak, optimized testing may include removing the adsorbed moisture on the surface of the device or component before testing. Otherwise, the evacuation curve in the fine leak region may be affected by the desorption of moisture from the surface of the device. Accordingly, the present methods may also include pre-baking or pre-heating the components over a prolonged time to remove surface moisture in order to ensure a more accurate evacuation curve in the fine leak regions. With sufficient refinement of chamber size and load-lock switching, device batch testing of many components at once may become possible and provide throughput gains.

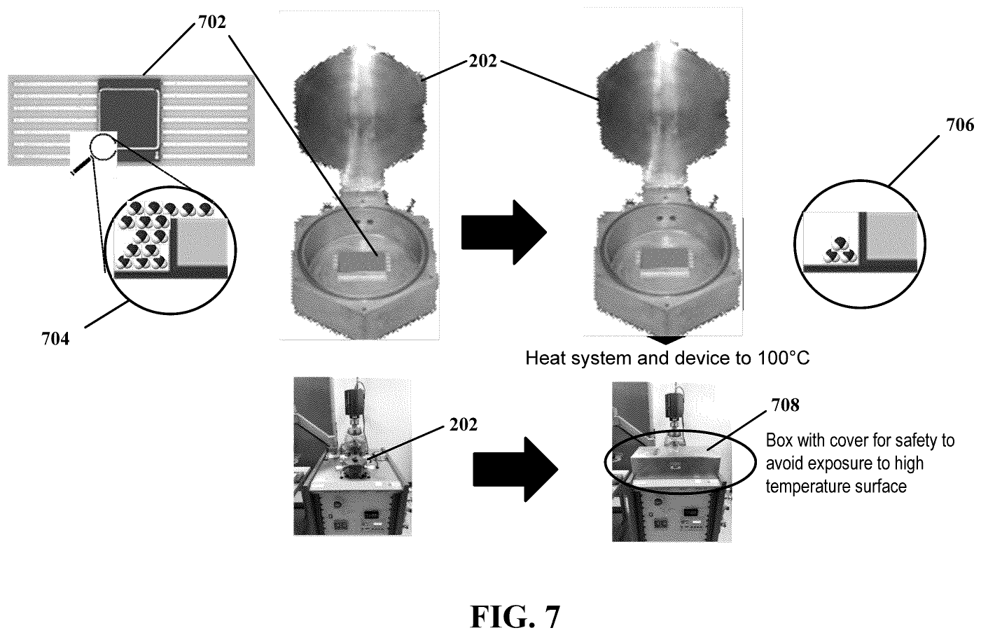

An example of the method and apparatus for pre-baking or heating a DUT is illustrated in FIG. 7. As shown, when a package DUT 702 is not pre-heated or pre-baked, there may be a large amount of water molecules that may be present in, on, or around the package as illustrated by the blown up illustration 704. Thus, when the device 702 is placed in chamber 202, for example, the fine leak region testing may be compromised and less accurate. Accordingly, the system (including the evacuation or vacuum chamber 202) may be heated, such as to 100 degrees Celsius as merely an approximate value, to allow desorption of the water molecules as shown in the blown up illustration 706, which occurs after the heating of chamber 202. As a practical concern, the chamber 202 may be enclosed with a box or cover 708 to provide safety by limiting a user's exposure to high temperature surfaces resulting from the preheating process.

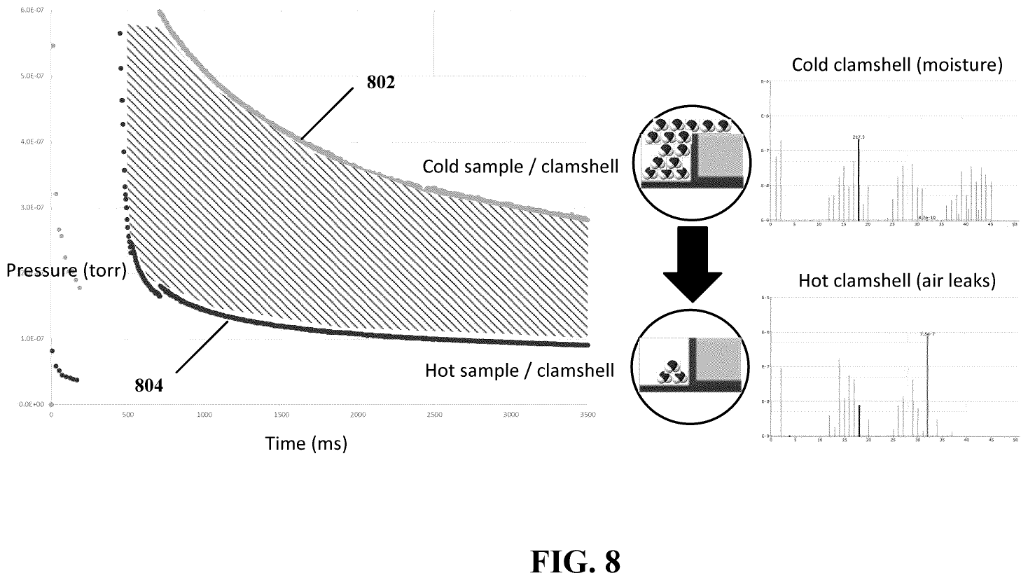

FIG. 8 illustrates an example of two evacuation curves, one 802 for a cold sample (DUT) and the other 804 for a hot or pre-baked sample. As may be seen, the evacuation curve for the hot sample provides better evaluation of actual air leaks due to removal of moisture, whereas the cold sample will include or show more moisture in the mass spectrometry profile with lower pressures and may not accurately find fine leaking devices.

It is also noted that the fine leak rate is fundamentally grounded in the evacuation curve, provided no volume loss, i.e., desorption of moisture from the device. Leak rates are given in (atm*cc*sec⁻¹). That is under a given pressure (atm), a given volume (cc) will exchange with the package per given time (sec). The evacuation curve measures the change in pressure as a function of time with volume held constant. Provided no volumetric change, an evacuation curve below 1×10⁻⁶ Torr provides a direct measurement of the leak rate.

In further aspects, it is noted that separately monitoring the constituent gases is proposed because the devices have known original backfilled gas contents. For example, it is known that devices will commonly have greater than 90% nitrogen originally backfilled. During the fine leak region of the evacuation curve, if the constituent gas emerging is predominantly that of the originally back-filled gas, additional insight may be gained for indicating that device under test is a leaker. The constituent gases measured inside each device will, however, be a function of the original back-filled gas, the leak rate, the environment of storage (pressure, temperature, gas composition), and/or time of storage. Thus, a known leaking device sitting at atmosphere for an extended period of time will no long display the contents of the backfilled gas, but also contents of the exchanged gas, commonly the gases found in the atmosphere such as O₂, Ar, H₂O, CO2, and N₂.

In yet further aspects, direct determination of the moisture (H₂O), nitrogen (N₂), and Argon (Ar) during the evacuation process may be accomplished with the mass spectrometer (e.g., 108). In a further aspect, this determination can be accomplished with a fast scan quadrupole setup and/or a time-of-flight setup.

In still further aspects, the pressure or evacuation curve may be measured using a pressure measurement unit or gauge such as a Pfeiffer PKR 3600 active Pirani cold cathode, as one example. The Pfeiffer PKR 360 in particular is a FullRange® Pirani cold cathode gauge that provides optimal measurements in the range of 1×10⁻⁹ to atmosphere. The PKR 360 features two measurement circuits: Pirani and Cold Cathode. The Pirani circuit is active at all times and the cold cathode circuit becomes active after passing the 1×10⁻¹ Torr threshold, providing a full range of measurement and allowing for use in a wide variety of applications. Vacuum pressure can be displayed via a DCU or Pfeiffer TPG 361 Vacuum Gauge controller.

Other aspects of the present method allow determination of a link between the leak rates and the lid seal voiding of the devices as determined by radiographic inspection. In this case, an artificial intelligence (AI) portion of the methodology use AI to process the radiographic images rather than using human eye for voiding measurements.

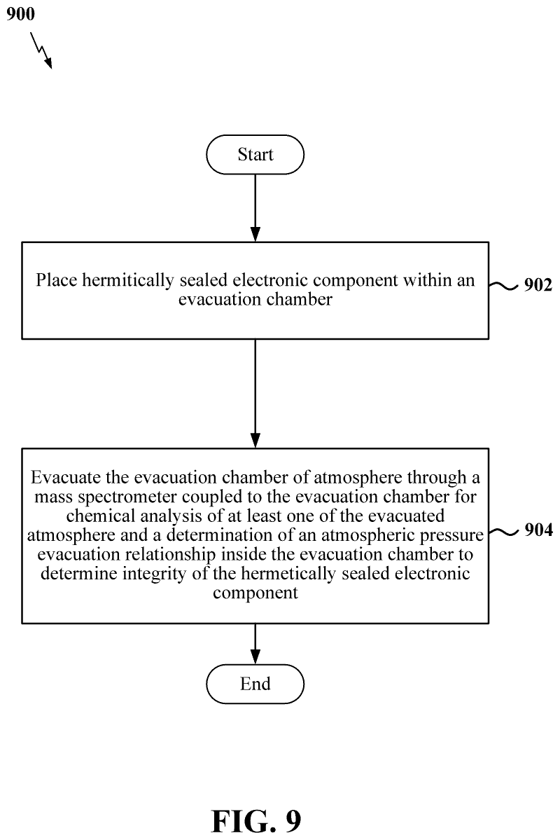

FIG. 9 illustrates a flowchart of an exemplary method 900 for performing evacuation testing of a hermetically sealed electronic component or other device under test (DUT) according to some aspects of the present disclosure. As illustrated, method 900 includes first placing the hermetically sealed electronic component in an evacuation chamber (e.g., 102 or 202, or other equivalent system used for evacuating atmosphere and/or creating a vacuum) as shown in block 902. Next, method 900 includes evacuating the evacuation chamber of atmosphere through a mass spectrometer coupled to the evacuation chamber for chemical analysis of at least one of the evacuated atmosphere and a determination of an atmospheric pressure evacuation relationship (or curve) inside the evacuation chamber to determine the integrity of the hermetically sealed electronic component as shown in block 904. In aspects, the determination of the integrity may involve comparing a predetermined reference evacuation curve of pressure over time to the evacuation curve of the present device under test, including over time periods to determine the leak rate or leakage of the device under test and at pressures and timeline for at least one of gross leak detection and fine leak detection. In further aspects, the leak detection may include both gross and fine leak detection without the use of tracer gas or radioisotope as is known in the prior art. In further aspects, the method 900 includes monitoring of the He/O₂ ratio, as well as directly determining moisture (H₂O), nitrogen (N₂), and Argon (Ar) during the evacuation process using mass spectrometry.

In further aspects, method 900 may include pre-heating the hermetically sealed electronic component in the chamber for a time period for removing moisture prior to evacuating the evacuation chamber of atmosphere. In yet further aspects of the method and associated apparatus, the evacuation chamber may include a load-lock system capable of temporarily isolating the evacuation chamber to accommodate the hermetically sealed electronic component device, wherein release of the load-lock system enables evacuation of the hermetically sealed electronic component, along with monitoring the emerging chemical components from the device with the mass spectrometer. Additionally, the evacuation chamber may be constructed or configured for vacuum conditions of approximately less than 1×10⁻⁶ Torr for implementing fine leak detection as was discussed above. In further aspects, the evacuation chamber (and system 100 as a whole) may be constructed or configured for ultra-high vacuum (e.g., approximately less than 1×10⁻⁶ Pascals, 1.0×10⁻⁸ mbar; or 7.5×10⁻⁹ Torr).

Further, method 900 may include monitoring the area under the evacuation curve along with the constituent chemical components to determine a direct measurement of a leak rate of the hermetically sealed electronic component. In still other aspects, method 900 includes determining the atmospheric pressure evacuation relationship by providing a reference curve of pressure in the evacuation chamber over time, determining a test curve of pressure in the evacuation over time when the hermetically sealed electronic component is within the evacuation chamber, and comparing the reference curve to the test curve to determine at least one of integrity of the hermetically sealed electronic component and a leak rate of the hermetically sealed electronic component.

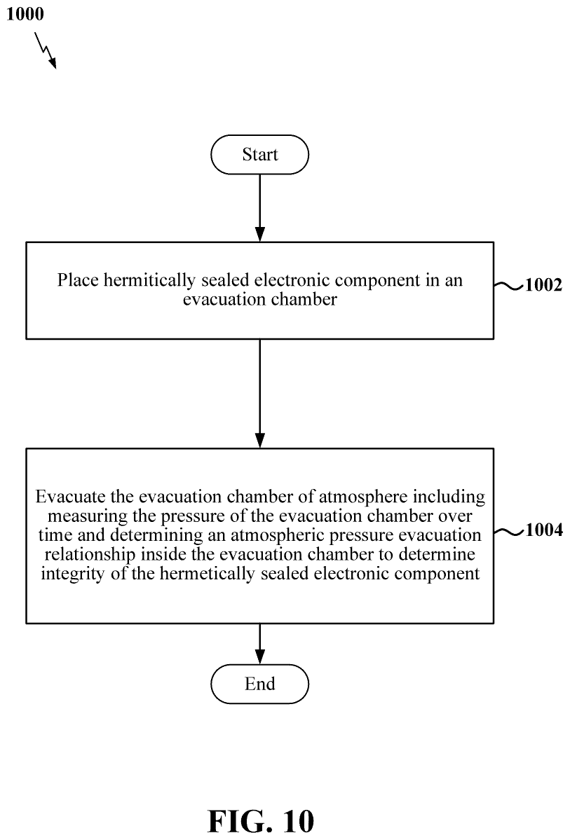

FIG. 10 illustrates a flowchart of another exemplary method 1000 for performing evacuation testing of a hermetically sealed electronic component or other device under test (DUT) according to some aspects of the present disclosure. It is noted that this method does not rely on using a mass spectrometer (although the method may be augmented, optimized, or enhanced using mass spectrometry), and uses comparison of the evacuation curves (See e.g., FIGS. 4-6 and 8) to determine the integrity a hermetically sealed electronic component (i.e., whether or not the component is leaking). As illustrated, method 1000 includes placing or disposing the hermitically sealed electronic component in an evacuation chamber as shown at block 1002. Furthermore, method 1000 includes evacuating the evacuation chamber of atmosphere including measuring the pressure of the evacuation chamber over time and determining an atmospheric pressure evacuation relationship inside the evacuation chamber to determine integrity of the hermetically sealed electronic component as shown at block 1004.

In yet further aspects, method 1000 includes determining the atmospheric pressure evacuation relationship through providing or predetermining a reference curve of pressure in the evacuation chamber over time, determining a test curve of pressure in the evacuation over time when the hermetically sealed electronic component is within the evacuation chamber, and comparing the reference curve to the test curve to determine at least one of integrity of the hermetically sealed electronic component and a leak rate of the hermetically sealed electronic component.

Although the invention has been described in detail with reference to certain preferred embodiments, variations and modifications exist within the spirit and scope of the invention as described and defined in the following claims.

What is claimed is:

1. A method for determining the integrity of a hermetically sealed electronic component, the method comprising:
placing the hermetically sealed electronic component in an evacuation chamber; and
evacuating the evacuation chamber of atmosphere through a mass spectrometer coupled to the evacuation chamber for chemical analysis of at least one of the evacuated atmosphere and a determination of an atmospheric pressure evacuation relationship inside the evacuation chamber to determine integrity of the hermetically sealed electronic component.

2. The method of claim 1, further comprising:
preheating the hermetically sealed electronic component in the evacuation chamber for a time period for removing moisture prior to evacuating the evacuation chamber of atmosphere.

3. The method of claim 1, further comprising:
the evacuation chamber including a load-lock system capable of temporarily isolating the chamber to accommodate the hermetically sealed electronic component device, wherein release of the load-lock system enables evacuation of the hermetically sealed electronic component, along with monitoring the emerging chemical components from the device with the mass spectrometer.

4. The method of claim 1, further comprising:
monitoring the area under the evacuation curve along with the constituent chemical components to determine a direct measurement of a leak rate of the hermetically sealed electronic component.

5. The method of claim 1, wherein the evacuation chamber is configured for vacuum of approximately 1×10⁻⁶ Torr or less for fine leak detection.

7. The method of claim 1, wherein the evacuation chamber is configured for ultra-high vacuum.

8. The method of claim 1, wherein determining the atmospheric pressure evacuation relationship comprises:
providing a reference curve of pressure in the evacuation chamber over time;
determining a test curve of pressure in the evacuation over time when the hermetically sealed electronic component is within the evacuation chamber; and
comparing the reference curve to the test curve to determine at least one of integrity of the hermetically sealed electronic component and a leak rate of the hermetically sealed electronic component.

9. A method for determining the integrity of a hermetically sealed electronic component, the method comprising:
placing the hermetically sealed electronic component in an evacuation chamber; and
evacuating the evacuation chamber of atmosphere through a mass spectrometer coupled to the evacuation chamber for chemical analysis of at least one of the evacuated atmosphere and a determination of an atmospheric pressure evacuation relationship inside the evacuation chamber to determine integrity of the hermetically sealed electronic component.

10. The method of claim 9, wherein determining the atmospheric pressure evacuation relationship comprises:
providing a reference curve of pressure in the evacuation chamber over time;
determining a test curve of pressure in the evacuation over time when the hermetically sealed electronic component is within the evacuation chamber; and
comparing the reference curve to the test curve to determine at least one of integrity of the hermetically sealed electronic component and a leak rate of the hermetically sealed electronic component.

11. The method of claim 9, further comprising:
preheating the hermetically sealed electronic component in the evacuation chamber for a time period for removing moisture prior to evacuating the evacuation chamber of atmosphere.

12. An apparatus for determining the integrity of a hermetically sealed electronic component comprising:
an evacuation chamber configured to receive the hermetically sealed electronic component;
an evacuation pump coupled to the evacuation chamber and configured to evacuate atmosphere from the evacuation chamber;
a pressure measurement device configured to measure pressure in the evacuation chamber; and
a controller communicatively coupled to the pressure measurement device, the controller configured to determine an atmospheric pressure evacuation relationship inside the evacuation chamber to determine the integrity of the hermetically sealed electronic component.

13. The apparatus of claim 12, further comprising:
a mass spectrometer coupled to at least one of the evacuation pump and the evacuation chamber and configured to perform mass spectrometry analysis of the atmosphere evacuated from the evacuation chamber.

14. The apparatus of claim 13, further comprising:
the evacuation chamber including a load-lock system capable of temporarily isolating the evacuation chamber to accommodate the hermetically sealed electronic component device, wherein release of the load-lock system enables evacuation of the hermetically sealed electronic component, along with monitoring the emerging chemical components from the device with the mass spectrometer.

15. The apparatus of claim 12, further comprising:
a heating device thermally coupled with at least the evacuation chamber and configured for preheating the hermetically sealed electronic component in the chamber for a time period in order to remove moisture prior to evacuating the evacuation chamber of atmosphere.

16. The apparatus of claim 12, wherein the controller is further configured to monitor an area under the evacuation curve along with the constituent chemical components to determine a direct measurement of a leak rate of the hermetically sealed electronic component.

17. The apparatus of claim 12, wherein the controller is further configured to determine the atmospheric pressure evacuation relationship by:
providing a predetermined reference curve of pressure in the evacuation chamber over time;
determining a test curve of pressure in the evacuation over time when the hermetically sealed electronic component is within the evacuation chamber; and
comparing the predetermined reference curve to the test curve to determine at least one of integrity of the hermetically sealed electronic component and a leak rate of the hermetically sealed electronic component.
